(19) United States
(12) Patent Application Publication
(10) Pub. No.: US 2026/0330684 A1
(43) Pub. Date: Oct. 22, 2026

(54) CALIBRATION METHOD, TRACKING DEVICE AND NON-TRANSITORY COMPUTER READABLE STORAGE MEDIUM

(71) Applicant: HTC Corporation, Taoyuan City (TW)

(72) Inventors: Jo-Han HSU, Taoyuan City (TW); Chao-Shuan HUANG, Taoyuan City (TW)

(21) Appl. No.: 19/182,553

(22) Filed: Apr. 17, 2025

(51) Int. Cl. G06T 7/80; G06V 10/145

(52) U.S. Cl. CPC G06T 7/80; G06V 10/145

(57) ABSTRACT

The present disclosure provides a calibration method and a tracking device. The tracking device is operable in a physical environment, and includes a pattern generator, cameras and a processor. The calibration method includes: by the pattern generator, generating a pattern in the physical environment; by the cameras, capturing image frames, respectively; by the processor, recognizing a pattern image corresponding to the pattern from each of the image frames, to obtain 2D position data of the pattern image; by the processor, using a predefined conversion table, to obtain 3D position data of the pattern according to the 2D position data of the pattern image; and by the processor, calculating optimum camera parameter data of each of the cameras according to the 2D position data of the pattern image and the 3D position data of the pattern, to calibrate the cameras.

### BACKGROUND

### Field of Invention

This disclosure relates to a method and a device, and in particular to a calibration method and a tracking device.

### Description of Related Art

These days, some existing electronic devices (e.g., wearable device) may have one or more tracking components (e.g., sensor, emitter, etc.). The position and/or orientation of the tracking component relative to the electronic device may be changed due to non-ideal factors, that is to say, the tracking component is misaligned. The electronic device applying the misaligned tracking component to tracking may provide unreliable tracking results, which further affects the practical applications of the electronic device. Therefore, it is necessary to propose new approaches for ensuring the tracking reliability of these electronic devices.

### SUMMARY

An aspect of present disclosure relates to a calibration method. The calibration method is applicable to a tracking device, and includes: by a pattern generator of the tracking device, generating a pattern in a physical environment where the tracking device is; by a plurality of cameras of the tracking device, capturing a plurality of image frames, respectively, wherein each of the plurality of image frames includes a pattern image corresponding to the pattern; by a processor of the tracking device, recognizing the pattern image from each of the plurality of image frames, to obtain 2D (two-dimensional) position data of the pattern image; by the processor, using a predefined conversion table, to obtain 3D (three-dimensional) position data of the pattern according to the 2D position data of the pattern image; and by the processor, calculating optimum camera parameter data of each of the plurality of cameras according to the 2D position data of the pattern image and the 3D position data of the pattern, to calibrate the plurality of cameras.

Another aspect of present disclosure relates to a tracking device. The tracking device is operable in a physical environment, and includes a pattern generator, a plurality of cameras and a processor. The pattern generator is configured to generate a pattern in the physical environment. The plurality of cameras is configured to capture a plurality of image frames, respectively, wherein each of the plurality of image frames includes a pattern image corresponding to the pattern. The processor is coupled to the pattern generator and the plurality of camera, and is configured to: recognize the pattern image from each of the plurality of image frames, to obtain 2D (two-dimensional) position data of the pattern image; use a predefined conversion table, to obtain 3D (three-dimensional) position data of the pattern according to the 2D position data of the pattern image; and calculate optimum camera parameter data of each of the plurality of cameras according to the 2D position data of the pattern image and the 3D position data of the pattern, to calibrate the plurality of cameras.

Another aspect of present disclosure relates to a non-transitory computer readable storage medium with a computer program to execute a calibration method, wherein the calibration method is applicable to a tracking device, and includes: by a pattern generator of the tracking device, generating a pattern in a physical environment where the tracking device is; by a plurality of cameras of the tracking device, capturing a plurality of image frames, respectively, wherein each of the plurality of image frames includes a pattern image corresponding to the pattern; by a processor of the tracking device, recognizing the pattern image from each of the plurality of image frames, to obtain 2D (two-dimensional) position data of the pattern image; by the processor, using a predefined conversion table, to obtain 3D (three-dimensional) position data of the pattern according to the 2D position data of the pattern image; and by the processor, calculating optimum camera parameter data of each of the plurality of cameras according to the 2D position data of the pattern image and the 3D position data of the pattern, to calibrate the plurality of cameras.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a block diagram of a tracking device operable by a user in accordance with some embodiments of the present disclosure;

FIG. 2 is a schematic diagram of an arrangement of multiple light emitters and multiple cameras of the tracking device in accordance with some embodiments of the present disclosure;

FIG. 3 is a schematic diagram of a pattern generated by the tracking device in accordance with some embodiments of the present disclosure;

FIG. 4 is a flow diagram of a calibration method of the tracking device in accordance with some embodiments of the present disclosure;

FIG. 5 is a schematic diagram of a scenario of the tracking device generating the pattern in accordance with some embodiments of the present disclosure;

FIG. 6 is a schematic diagram of the pattern generated by the tracking device in accordance with some embodiments of the present disclosure;

FIG. 7 is a schematic diagram of an image frame captured by the tracking device in accordance with some embodiments of the present disclosure; and

FIG. 8 is a schematic diagram of a predefined conversion table in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

As used herein, “coupled” and “connected” may be used to indicate that two or more elements physical or electrical contact with each other directly or indirectly, and may also be used to indicate that two or more elements cooperate or interact with each other.

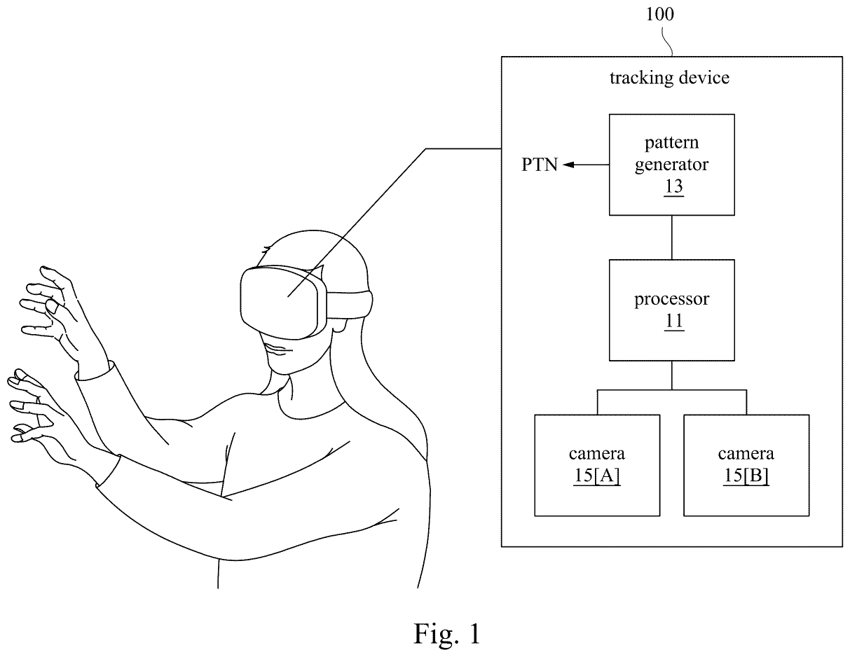

Referring to FIG. 1, FIG. 1 is a block diagram of a tracking device 100 in accordance with some embodiments of the present disclosure. In some embodiments, the tracking device 100 is operable in a physical environment, such as a road, a gaming place, a workplace, a house, etc. For example, the tracking device 100 is configured to track an object (not shown) and/or itself in the physical environment.

In some embodiments, as shown in FIG. 1, the tracking device 100 is implemented by a wearable device, such as a head mounted display (HMD). Accordingly, the tracking device 100 is worn and operated by a user U1. The wearable device can be operated as an immersive system. The immersive system is configured to provide an immersive experience for the user U1. For example, the user's perception of the physical environment is replaced or embellished with an immersive environment, such as an augmented reality (AR) environment, a virtual reality (VR) environment, a mixed reality (MR) environment, etc. The immersive environment includes at least one virtual object, which cannot be directly seen in the physical environment by the user U1. In addition, the user U1 can control the at least one virtual object in the immersive environment by operating at least one controller communicatively coupled to the tracking device 100 or by some hand movements.

It should be understood that the present disclosure is not limited to the above embodiments. In some embodiments, the tracking device 100 can be implemented by vehicular equipment applicable to a vehicle (e.g., car) operable by the user U1 or an autonomous mobile robot (e.g., sweeping robot). Both the vehicular equipment and the autonomous mobile robot have to track and sense in the physical environment.

In the above embodiments, when the tracking device 100 is operated in the physical environment, one or more components (e.g., sensor, emitter, etc.) of the tracking device 100 are possibly misaligned due to physical decay or physical impact. For example, the position and/or orientation of the sensor relative to the tracking device 100 or other components on the tracking device 100 are changed, that is, translation and/or rotation occur on the sensor of the tracking device 100. If the sensor is used for tracking, the tracking result of the tracking device 100 becomes unreliable due to the misalignment of the sensor. In these cases, the tracking device 100 can calibrate the one or more components, which are misaligned, to ensure the reliability of the tracking result. Accordingly, in some embodiments, as shown in FIG. 1, the tracking device 100 includes a processor 11, a pattern generator 13 and multiple cameras 15[A] and 15[B]. In particular, the processor 11 is electrically and/or communicatively coupled to the pattern generator 13 and the cameras 15[A] and 15[B].

In some embodiments, the pattern generator 13 is configured to generate a pattern PTN in the physical environment. In particular, the pattern generator 13 includes at least one pair of light emitting elements. The light emitting element can be implemented by one or more emitters, such as light emitting diode (LED), laser diode (LD), etc. The light emitting elements are configured to emit multiple lights, respectively. The lights are different in one or more characteristics, such as light distribution, light wavelength, etc. Accordingly, when the lights strike one plane in the physical environment, multiple light spot patterns, which are different in shape, color, etc., are generated on the plane to form the pattern PTN.

In some embodiments, each of the cameras 15[A] and 15[B] is configured to capture multiple images in the physical environment. It should be understood that these images may include at least one of images of the pattern PTN, images of the whole or partial physical environment and images of one or more physical parts of the user U1.

In some embodiments, by applying some computer vision based localization technologies (e.g., Simultaneous Localization and Mapping (SLAM)) to the images captured by the cameras 15[A] and 15[B], the processor 11 is configured to calculate the position and/or orientation of the object and/or the tracking device 100 in the physical environment. That is to say, the tracking device 100 can track the object and/or itself in the physical environment.

In addition, in some embodiments where at least one of the cameras 15[A] and 15[B] is misaligned, by applying some known object detection and/or image recognition algorithms, the processor 11 is configured to detect the pattern PTN generated by the pattern generator 13 according to the images captured by the cameras 15[A] and 15[B], so as to obtain trackable and definite reference datum in the physical environment. The processor 11 can then use the reference datum for the calibration of the at least one of the cameras 15[A] and 15[B]. In particular, in response to the at least one of the cameras 15[A] and 15[B] being misaligned, one or more camera parameters (e.g., 6 degree of freedom (6 DOF), focal length, optical center, distortion coefficient, etc.) of the at least one of the cameras 15[A] and 15[B], which is set previously, would be updated and/or adjusted, such that the tracking device 100 tracking according to the updated and/or adjusted one or more camera parameters can provide a reliable tracking result.

In the above embodiments, the processor 11 can be implemented by a central processing unit (CPU), an application-specific integrated circuit (ASIC), a microprocessor, a system on a Chip (SoC) or other suitable processing circuits.

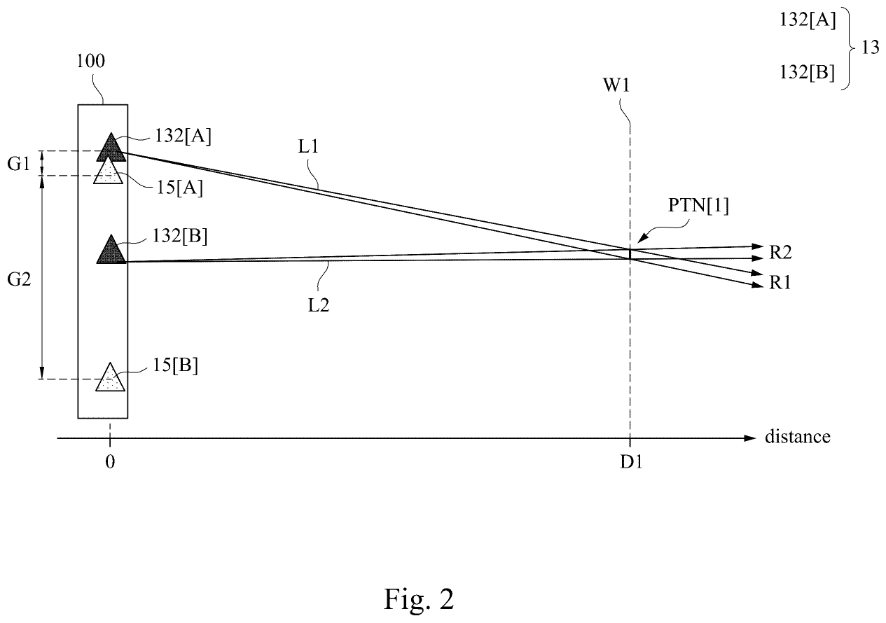

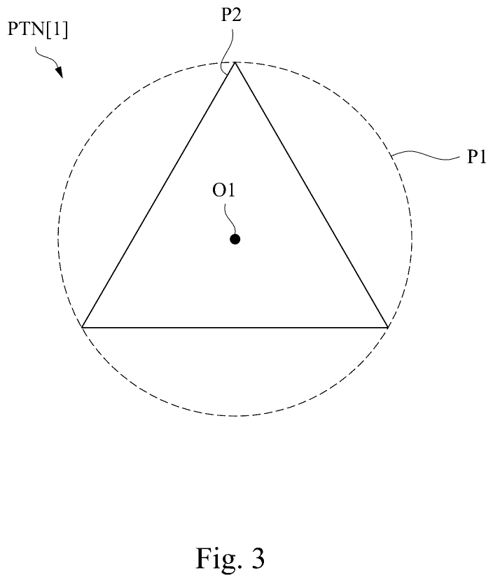

The pattern generator 13 would be further described with reference to FIGS. 2 and 3. FIG. 2 is a schematic diagram of an arrangement of the pattern generator 13 and the cameras 15[A] and 15[B] of the tracking device 100 in accordance with some embodiments of the present disclosure. FIG. 3 is a schematic diagram of the pattern PTN in accordance with some embodiments of the present disclosure. In some embodiments, as shown in FIG. 2, the pattern generator 13 includes two light emitters 132[A] and 132[B]. In particular, the camera 15[A] is arranged between the light emitter 132[A] and the light emitter 132[B], and the light emitter 132[B] is arranged between the camera 15[A] and the camera 15[B]. The light emitter 132[A] is configured to emit a structured light L1 along a direction R1, and the light emitter 132[B] is configured to emit a structured light L2 along a direction R2.

Referring to FIGS. 2 and 3 together, when the structured light L1 and the structured light L2 strike one plane in the physical environment, a light pattern P1 and a light pattern P2 are projected in the physical environment to form the pattern PTN[1]. In particular, the direction R1 and the direction R2 are preset to intersect with each other, so that both a center of light pattern P1 and a center the light pattern P2 are overlapped with a point O1 on a plane surface W1 in the physical environment when the structured light L1 and the structured light L2 strike the plane surface W1. As shown in FIG. 3, the plane surface W1 is located at a predetermined distance D1 in front of the tracking device 100. That is to say, the light pattern P1 and the light pattern P2 are preset to be centrally overlapped with each other at the predetermined distance D1 in front of the tracking device 100.

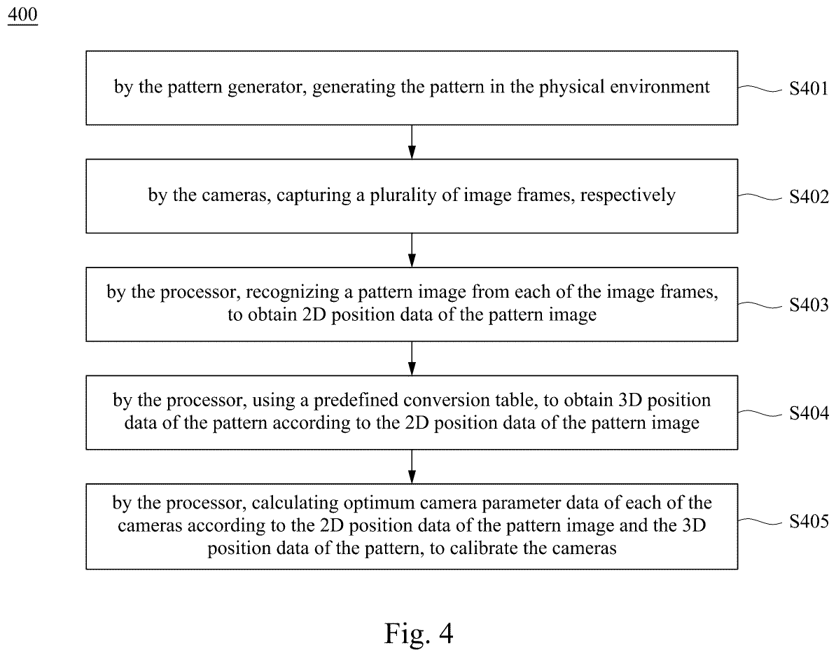

In addition, as shown in FIG. 2, a distance G1 between the light emitter 132[A] and the camera 15[A] is shorter than a distance G2 between the camera 15[A] and the camera 15[B]. In such arrangements, a change in the relative relation between the camera 15[A] and the camera 15[B] due to the physical decay or impact is more significant than a change in the relative relation between the light emitter 132[A] and the camera 15[A] due to the physical decay or impact. Notably, in some embodiments, the tracking device 100 can calibrate one or more camera parameters of at least one of the cameras 15[A] and 15[B] by generating the pattern PTN in the physical environment, to adapt to the change in the relative relation between the camera 15[A] and the camera 15[B]. The calibration of at least one of the cameras 15[A] and 15[B] would be described in detail below with reference to FIG. 4.

FIG. 4 is a flow diagram of a calibration method 400 applicable to the tracking device 100 in accordance with some embodiments of the present disclosure. In some embodiments, as shown in FIG. 4, the calibration method 400 includes operations S401-S405. However, the present disclosure should not be limited thereto.

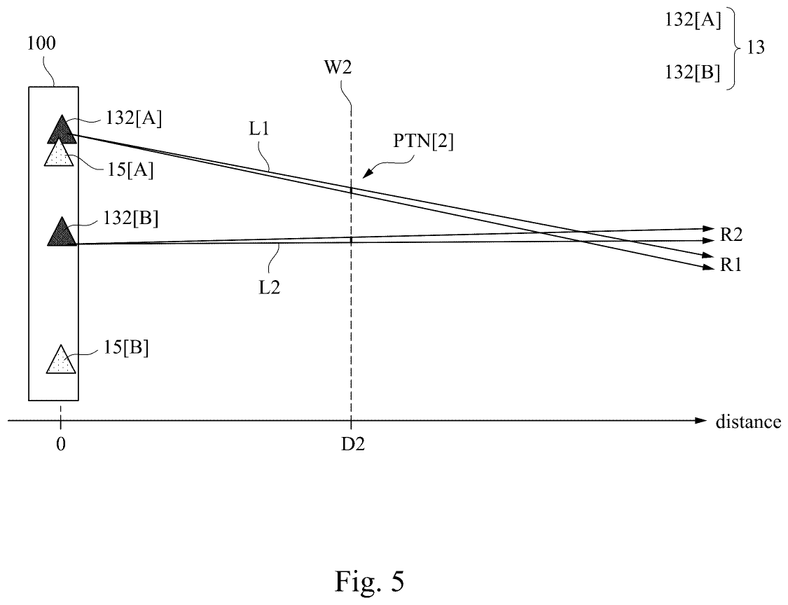

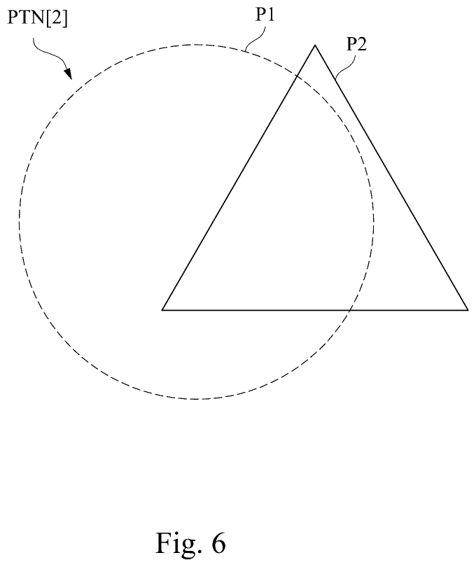

In operation S401, the pattern generator 13 generates the pattern PTN in the physical environment, which would be described in detail below with reference to FIGS. 5 and 6. FIG. 5 is a schematic diagram of a scenario of the pattern generator 13 generating the pattern PTN[2] in the physical environment in accordance with some embodiments of the present disclosure. FIG. 6 is a schematic diagram of the pattern PTN[2] in accordance with some embodiments of the present disclosure.

In some embodiments of operation S401, the light emitter 132[A] emits the structured light L1 along the direction R1, and the light emitter 132[B] emits the structured light L2 along the direction R2. As shown in FIG. 5, the structured light L1 and the structured light L2 strike another plane surface W2 in the physical environment, which is located at a distance D2 in front of the tracking device 100. Accordingly, referring to FIGS. 5 and 6 together, the light pattern P1 and the light pattern P2 are projected on the plane surface W2 to form the pattern PTN[2]. It should be understood that the center of the light pattern P1 and the center of the light pattern P2 are spaced apart in the pattern PTN[2] because the distance D2 is shorter than the predetermined distance D1.

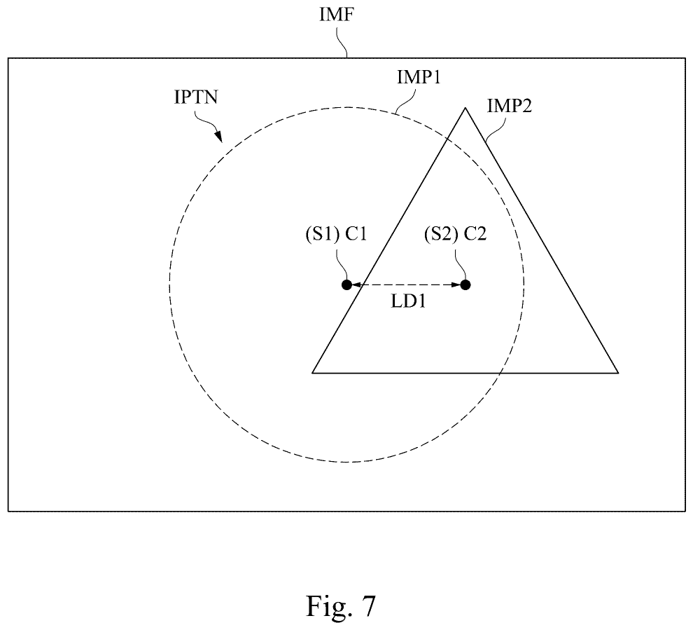

In operation S402, the cameras 15[A] and 15[B] capture a plurality of image frames IMF, respectively. Referring to FIG. 7, FIG. 7 is a schematic diagram of one of the image frames IMF in accordance with some embodiments of the present disclosure. In some embodiments, the image frame IMF as shown in FIG. 7 is captured by the camera 15[A].

In operation S403, the processor 11 recognizes a pattern image IPTN from each of the image frames IMF, to obtain 2D (two-dimensional) position data of the pattern image IPTN. It should be understood that the pattern image IPTN in each of the image frames IMF is corresponding to the pattern PTN generated by the pattern generator 13 in the physical environment. For example, referring to FIGS. 6 and 7 together, the pattern image IPTN in the image frame IMF captured by the camera 15[A] is corresponding to the pattern PTN[2] generated on the plane surface W2. Accordingly, in some embodiments, the processor 11 detects a light image IMP1 and a light image IMP2, which are corresponding to the light pattern P1 and the light pattern P2 forming the pattern PTN, respectively, in each of the image frames IMF, to recognize the pattern image IPTN. The shapes and colors of the light patterns P1 and P2 can be preset by the user U1. Thus, the detections of the light images IMP1 and IMP2 can be accomplished by applying some shape and/or color detection algorithms and/or detectors.

When the light image IMP1 and the light image IMP2 are detected, the processor 11 can obtain a center C1 of the light image IMP1 and a center C2 of the light image IMP2. Accordingly, in some embodiments, the processor 11 calculates a pixel coordinate of the center C1 in the image frame IMF of FIG. 7 as a 2D coordinate S1 of the light image IMP1, and calculates a pixel coordinate of the center C2 in the image frame IMF of FIG. 7 as a 2D coordinate S2 of the light image IMP2. That is to say, the 2D coordinate S1 of the light image IMP1 and the 2D coordinate S2 of the light image IMP2 in each of the image frames IMF are calculated.

In some embodiment, the processor 11 can use the 2D coordinate S1 of the light image IMP1 and the 2D coordinate S2 of the light image IMP2 as the 2D position data of the pattern image IPTN. However, the present disclosure is not limited herein. For example, in some embodiments, a linear distance LD1 between the 2D coordinate S1 of the light image IMP1 and the 2D coordinate S2 of the light image IMP2 is calculated as the 2D position data of the pattern image IPTN. Also, in some embodiments, the processor 11 records the pixel coordinate of each feature point of both the light images IMP1 and IMP2 (e.g., the 2D coordinate S1 corresponding to the center C1 of the light image IMP1, the 2D coordinate S2 corresponding to the center C2 of the light image IMP2, the pixel coordinate of each angle of the light image IMP2 (which is a triangle as shown in FIG. 7), etc.), to obtain a relative position relation between the light pattern P1 and the light pattern P2 as the 2D position data of the pattern image IPTN. It can be seen from the above descriptions that the 2D position data of the pattern image IPTN can include at least one of the linear distance LD1 between the 2D coordinates S1 and S2, the relative position relation between the light patterns P1 and P2 and both of the 2D coordinates S1 and S2.

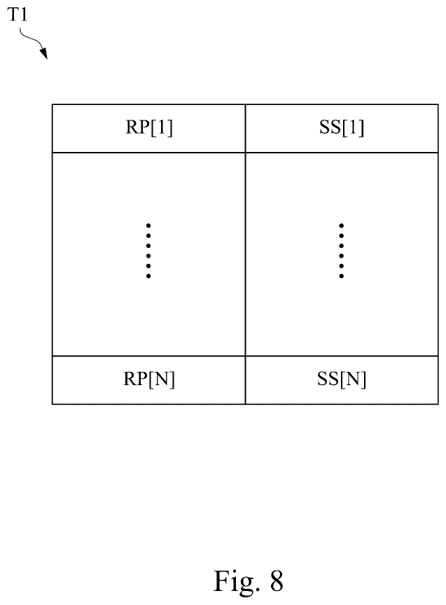

In operation S404, the processor 11 uses a predefined conversion table T1, to obtain 3D (three-dimensional) position data of the pattern PTN according to the 2D position data of the pattern image IPTN. Referring to FIG. 8, FIG. 8 is a schematic diagram of the predefined conversion table T1 in accordance with some embodiments of the present disclosure. In some embodiments, as shown in FIG. 8, the predefined conversion table T1 includes a plurality of predefined 3D coordinates SS[1]-SS[N] and a plurality of predefined relative position relations RP[1]-RP[N] between the light patterns P1 and P2. In FIG. 8, N is a positive integer greater than 1. The predefined 3D coordinates SS[1]-SS[N] are corresponding to the predefined relative position relations RP[1]-RP[N], respectively. For example, one of the predefined relative position relations RP[1]-RP[N] may represent the pattern PTN[1] generated on the plane surface W1 as shown in FIG. 3, and a corresponding one of the predefined 3D coordinates SS[1]-SS[N] may indicate a space coordinate at the predetermined distance D1 in front of the tracking device 100. In another example, one of the predefined relative position relations RP[1]-RP[N] may represent the pattern PTN[2] generated on the plane surface W2 as shown in FIG. 6, and a corresponding one of the predefined 3D coordinates SS[1]-SS[N] may indicate a space coordinate at the distance D2 in front of the tracking device 100.

In some embodiments of operation S404, the processor 11 compares the predefined relative position relations RP[1]-RP[N] with the relative position relation included by the 2D position data. When the relative position relation is matched to one of the predefined relative position relations RP[1]-RP[N], the processor 11 can obtain one of the predefined 3D coordinates SS[1]-SS[N] corresponding to the one of the predefined relative position relations RP[1]-RP[N] from the predefined conversion table T1, and uses the one of the predefined 3D coordinates SS[1]-SS[N] as the 3D position data of the pattern PTN. It can be seen from these descriptions that the processor 11 is configured to find one 3D coordinate (i.e., the reference datum) by comparing the predefined relative position relations RP[1]-RP[N] with the relative position relation indicated by the 2D position data as the 3D position data of the pattern PTN.

In the above embodiments of operation S404, when the relative position relation included by the 2D position data is not matched to any of the predefined relative position relations RP[1]-RP[N], the processor 11 can obtains one 3D coordinate corresponding to the relative position relation included by the 2D position data by applying interpolation and/or extrapolation to the predefined conversion table T1.

In addition, the predefined conversion table T1 is not limited to the embodiments of FIG. 8. For example, in some embodiments, the predefined relative position relations RP[1]-RP[N] in the predefined conversion table T1 can be replaced with a plurality of predefined distances between the center C1 of the light image IMP1 and the center C2 of the light image IMP2, or can be replaced with a plurality of pairs of predefined 2D coordinates of the light images IMP1 and IMP2.

In operation S405, the processor 11 calculates optimum camera parameter data of each of the cameras 15[A] and 15[B] according to the 2D position data of the pattern image IPTN and the 3D position data of the pattern PTN, to calibrate the cameras 15[A] and 15[B]. In some embodiments, the processor 11 can perform any known technologies, such as the Bundle Adjustment, to calculate the optimum camera parameter data of each of the cameras 15[A] and 15[B], which is known by person having ordinary skill in the art of the present disclosure.

In some embodiments of operation S405, in order to adapt to the significant change in the relative relation between the cameras 15[A] and 15[B] due to the physical decay or impact, the processor 11 can replace original camera parameter data of the camera 15[B] with the optimum camera parameter data of the camera 15[B]. The original camera parameter data of the camera 15[B] may be preset to correspond to an initial configuration of the camera 15[B] relative to the tracking device 100 (e.g., the position and/or orientation of the camera 15[B] relative to the tracking device 100). The initial configuration of the camera 15[B] may be changed into another configuration due to the physical decay or impact. The optimum camera parameter data of the camera 15[B] is generated to correspond to the another configuration. It should be understood that each of the original camera parameter data and the optimum camera parameter data includes one or more camera parameters, such as 6 DOF, focal length, optical center, distortion coefficient, etc.

As can be seen from the above embodiments of the present disclosure, in the condition that one or more sensors used for tracking (e.g., at least one of the cameras 15[A] and 15[B]) are misaligned due to the physical decay or impact, the tracking device 100 can obtain the trackable and definite reference datum (e.g., the 3D position data of the pattern PTN) by generating the pattern PTN in the physical environment, and calculates one or more new parameters (e.g., the optimum camera parameter data) for calibrations of one or more sensors. In such way, the tracking device 100 can adapt to the misalignment of one or more sensors, and thus can provide the reliable tracking result. In sum, the tracking device 100 and the calibration method 400 of the present disclosure have advantages of high reliability of tracking, calibrating without additional trackable accessory.

The disclosed methods, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the at least one processor to provide a unique apparatus that operates analogously to application specific logic circuits.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A calibration method, applicable to a tracking device, and comprising:
by a pattern generator of the tracking device, generating a pattern in a physical environment where the tracking device is;
by a plurality of cameras of the tracking device, capturing a plurality of image frames, respectively, wherein each of the plurality of image frames comprises a pattern image corresponding to the pattern;
by a processor of the tracking device, recognizing the pattern image from each of the plurality of image frames, to obtain 2D (two-dimensional) position data of the pattern image;
by the processor, using a predefined conversion table, to obtain 3D (three-dimensional) position data of the pattern according to the 2D position data of the pattern image; and
by the processor, calculating optimum camera parameter data of each of the plurality of cameras according to the 2D position data of the pattern image and the 3D position data of the pattern, to calibrate the plurality of cameras.

2. The calibration method of claim 1, wherein the pattern generator comprises a first light emitter and a second light emitter, and by the pattern generator, generating the pattern in the physical environment comprises:
by the first light emitter, emitting a first structured light along a first direction, to project a first light pattern in the physical environment; and
by the second light emitter, emitting a second structured light along a second direction, to project a second light pattern in the physical environment, wherein the first light pattern and the second light pattern form the pattern, and
wherein the first direction and the second direction are intersected, so that the first light pattern is centrally overlapped with the second light pattern at a predetermined distance in front of the tracking device.

3. The calibration method of claim 2, wherein the first light pattern and the second light pattern are different in shape and/or color.

4. The calibration method of claim 1, wherein the pattern comprises a first light pattern and a second light pattern, and by the processor, recognizing the pattern image from each of the plurality of image frames, to obtain the 2D position data of the pattern image comprises:
detecting a first light image and a second light image, which are corresponding to the first light pattern and the second light pattern, respectively, in each of the plurality of image frames; and
calculating a first 2D coordinate of the first light image and a second 2D coordinate of the second light image in each of the plurality of image frames, to generate the 2D position data of the pattern image.

5. The calibration method of claim 4, wherein the 2D position data of the pattern image comprises at least one of a linear distance between the first 2D coordinate and the second 2D coordinate and a relative position relation between the first light pattern and the second light pattern.

6. The calibration method of claim 1, wherein the pattern is formed by a first light pattern and a second light pattern, the predefined conversion table comprises a plurality of predefined 3D coordinates and a plurality of predefined relative position relations between the first light pattern and the second light pattern, and by the processor, using the predefined conversion table, to obtain the 3D position data of the pattern according to the 2D position data of the pattern image comprises:
finding a 3D coordinate by comparing the plurality of predefined relative position relations with a relative position relation indicated by the 2D position data as the 3D position data of the pattern.

7. The calibration method of claim 1, wherein the pattern generator comprises a first light emitter and a second light emitter, a first camera of the plurality of cameras is between the first light emitter and the second light emitter, the second light emitter is between a second camera of the plurality of cameras and the first camera, a distance between the first light emitter and the first camera is shorter than a distance between the first camera and the second camera, and original camera parameter data of the second camera is replaced with the optimum camera parameter data of the second camera.

8. A tracking device, operable in a physical environment, and comprising:
a pattern generator, configured to generate a pattern in the physical environment;
a plurality of cameras, configured to capture a plurality of image frames, respectively, wherein each of the plurality of image frames comprises a pattern image corresponding to the pattern; and
a processor, coupled to the pattern generator and the plurality of camera, and configured to:
recognize the pattern image from each of the plurality of image frames, to obtain 2D (two-dimensional) position data of the pattern image;
use a predefined conversion table, to obtain 3D (three-dimensional) position data of the pattern according to the 2D position data of the pattern image; and
calculate optimum camera parameter data of each of the plurality of cameras according to the 2D position data of the pattern image and the 3D position data of the pattern, to calibrate the plurality of cameras.

9. The tracking device of claim 8, wherein the pattern generator comprises:
a first light emitter, configured to emit a first structured light along a first direction, to project a first light pattern in the physical environment; and
a second light emitter, configured to emit a second structured light along a second direction, to project a second light pattern in the physical environment, wherein the first light pattern and the second light pattern form the pattern, and
wherein the first direction and the second direction are intersected, so that the first light pattern is centrally overlapped with the second light pattern at a predetermined distance in front of the tracking device.

10. The tracking device of claim 9, wherein the first light pattern and the second light pattern are different in shape and/or color.

11. The tracking device of claim 8, wherein the pattern comprises a first light pattern and a second light pattern, and the processor is configured to:
detect a first light image and a second light image, which are corresponding to the first light pattern and the second light pattern, respectively, in each of the plurality of image frames; and
calculate a first 2D coordinate of the first light image and a second 2D coordinate of the second light image in each of the plurality of image frames, to generate the 2D position data of the pattern image.

12. The tracking device of claim 11, wherein the 2D position data of the pattern image comprises at least one of a linear distance between the first 2D coordinate and the second 2D coordinate and a relative position relation between the first light pattern and the second light pattern.

13. The tracking device of claim 8, wherein the pattern is formed by a first light pattern and a second light pattern, the predefined conversion table comprises a plurality of predefined 3D coordinates and a plurality of predefined relative position relations between the first light pattern and the second light pattern, and the processor is configured to:
find a 3D coordinate by comparing the plurality of predefined relative position relations with a relative position relation indicated by the 2D position data as the 3D position data of the pattern.

14. The tracking device of claim 8, wherein the pattern generator comprises a first light emitter and a second light emitter, a first camera of the plurality of cameras is between the first light emitter and the second light emitter, the second light emitter is between a second camera of the plurality of cameras and the first camera, a distance between the first light emitter and the first camera is shorter than a distance between the first camera and the second camera, and original camera parameter data of the second camera is replaced with the optimum camera parameter data of the second camera.

15. A non-transitory computer readable storage medium with a computer program to execute a calibration method, wherein the calibration method is applicable to a tracking device, and comprises:
by a pattern generator of the tracking device, generating a pattern in a physical environment where the tracking device is;
by a plurality of cameras of the tracking device, capturing a plurality of image frames, respectively, wherein each of the plurality of image frames comprises a pattern image corresponding to the pattern;
by a processor of the tracking device, recognizing the pattern image from each of the plurality of image frames, to obtain 2D (two-dimensional) position data of the pattern image;
by the processor, using a predefined conversion table, to obtain 3D (three-dimensional) position data of the pattern according to the 2D position data of the pattern image; and
by the processor, calculating optimum camera parameter data of each of the plurality of cameras according to the 2D position data of the pattern image and the 3D position data of the pattern, to calibrate the plurality of cameras.

16. The non-transitory computer readable storage medium of claim 15, wherein the pattern generator comprises a first light emitter and a second light emitter, and by the pattern generator, generating the pattern in the physical environment comprises:
by the first light emitter, emitting a first structured light along a first direction, to project a first light pattern in the physical environment; and
by the second light emitter, emitting a second structured light along a second direction, to project a second light pattern in the physical environment, wherein the first light pattern and the second light pattern form the pattern, and
wherein the first direction and the second direction are intersected, so that the first light pattern is centrally overlapped with the second light pattern at a predetermined distance in front of the tracking device.

17. The non-transitory computer readable storage medium of claim 15, wherein the pattern comprises a first light pattern and a second light pattern, and by the processor, recognizing the pattern image from each of the plurality of image frames, to obtain the 2D position data of the pattern image comprises:
detecting a first light image and a second light image, which are corresponding to the first light pattern and the second light pattern, respectively, in each of the plurality of image frames; and
calculating a first 2D coordinate of the first light image and a second 2D coordinate of the second light image in each of the plurality of image frames, to generate the 2D position data of the pattern image.

18. The non-transitory computer readable storage medium of claim 17, wherein the 2D position data of the pattern image comprises at least one of a linear distance between the first 2D coordinate and the second 2D coordinate and a relative position relation between the first light pattern and the second light pattern.

19. The non-transitory computer readable storage medium of claim 15, wherein the pattern is formed by a first light pattern and a second light pattern, the predefined conversion table comprises a plurality of predefined 3D coordinates and a plurality of predefined relative position relations between the first light pattern and the second light pattern, and by the processor, using the predefined conversion table, to obtain the 3D position data of the pattern according to the 2D position data of the pattern image comprises:
finding a 3D coordinate by comparing the plurality of predefined relative position relations with a relative position relation indicated by the 2D position data as the 3D position data of the pattern.

20. The non-transitory computer readable storage medium of claim 15, wherein the pattern generator comprises a first light emitter and a second light emitter, a first camera of the plurality of cameras is between the first light emitter and the second light emitter, the second light emitter is between a second camera of the plurality of cameras and the first camera, a distance between the first light emitter and the first camera is shorter than a distance between the first camera and the second camera, and original camera parameter data of the second camera is replaced with the optimum camera parameter data of the second camera.
